(19) United States
(12) Patent Application Publication
(10) Pub. No.: US 2007/0153540 A1
(43) Pub. Date: Jul. 5, 2007

(54) Decorative lampshade

(76) Inventor: Vincent Lin, Hsin-Chu City (TW)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 11/402,578

(22) Filed: Apr. 12, 2006

(30) Foreign Application Priority Data
Jan. 5, 2006 (CN) 200620000425.3

(51) Int. Cl. F21V 1/04

(52) U.S. Cl. 362/565; 362/358; 362/555

(57) ABSTRACT

A decorative lampshade includes a frame defining an inner space and including a plurality of interconnected ribs surrounding the inner space; and a plurality of transparent filaments disposed around the inner space and attached randomly to the ribs. Each of the transparent filaments bridges at least two adjacent ones of the ribs so as to form a plurality of openings between each two adjacent ones of the ribs.

### CROSS-REFERENCE TO RELATED APPLICATION

This application claims priority of Chinese Application No. 200620000425.3, filed on Jan. 25, 2006.

### BACKGROUND OF THE INVENTION

1. Field of the Invention

The invention relates to a decorative lampshade, more particularly to a decorative lampshade that includes transparent filaments attached to a frame.

2. Description of the Related Art

Conventional lampshades normally include a frame and a cover sheet covering the frame. However, the appearance of the conventional lampshade is relatively dull.

### SUMMARY OF THE INVENTION

Therefore, the object of the present invention is to provide a decorative lampshade that can overcome the above drawback associated with the prior art.

Accordingly, a decorative lampshade assembly of this invention comprises: a frame defining an inner space and including a plurality of interconnected ribs surrounding the frame space; and a plurality of transparent filaments disposed around the inner space and attached randomly to the ribs so as to form into a net-like structure surrounding the inner space.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of a decorative lampshade with a light bulb according to the present invention;

FIG. 2 is a schematic view of the second preferred embodiment of the decorative lampshade with a light bulb according to the present invention; and

FIG. 3 is a schematic view of the third preferred embodiment of the decorative lampshade with a light bulb according to the present invention.

### DETAILED DESCRIPTION OF THE PREFERRED EMBODIMENTS

Before the present invention is described in greater detail with reference to the accompanying preferred embodiments, it should be noted here in that like elements are denoted by the same reference numerals throughout the disclosure.

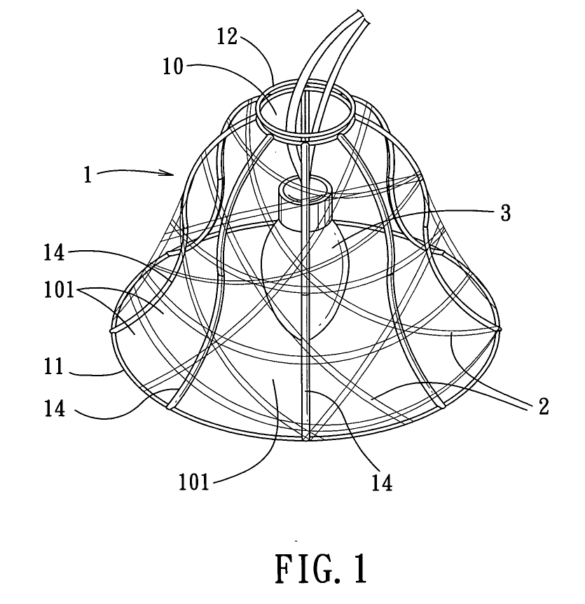

Referring to FIG. 1, the first preferred embodiment of a decorative lampshade according to the present invention is shown to include: a frame 1 defining an inner space 10 for receiving a light emitting element, such as a light bulb 3, therein and including a plurality of interconnected ribs 14 surrounding the frame space 10; and a plurality of transparent filaments 2 disposed around the inner space 10 and attached randomly to the ribs 14 so as to form into a net-like structure surrounding said inner space. The light bulb 3 is disposed at a central region of the inner space 10 in the frame 1.

Each of the transparent filaments 2 bridges at least two adjacent ones of the ribs 14 so as to form a plurality of openings 101 between each two adjacent ones of the ribs 14. The frame 1 further includes upper and lower rings 12, 11. The ribs 14 interconnect the upper and lower rings 12, 11, and are equiangularly displaced from each other in this embodiment.

Each of the transparent filaments 2 is made of a thermoplastic material or glass, and is formed on the ribs 14 by applying a semi-melted thermoplastic material or glass thereto, followed by cooling the semi-melted thermoplastic material or glass.

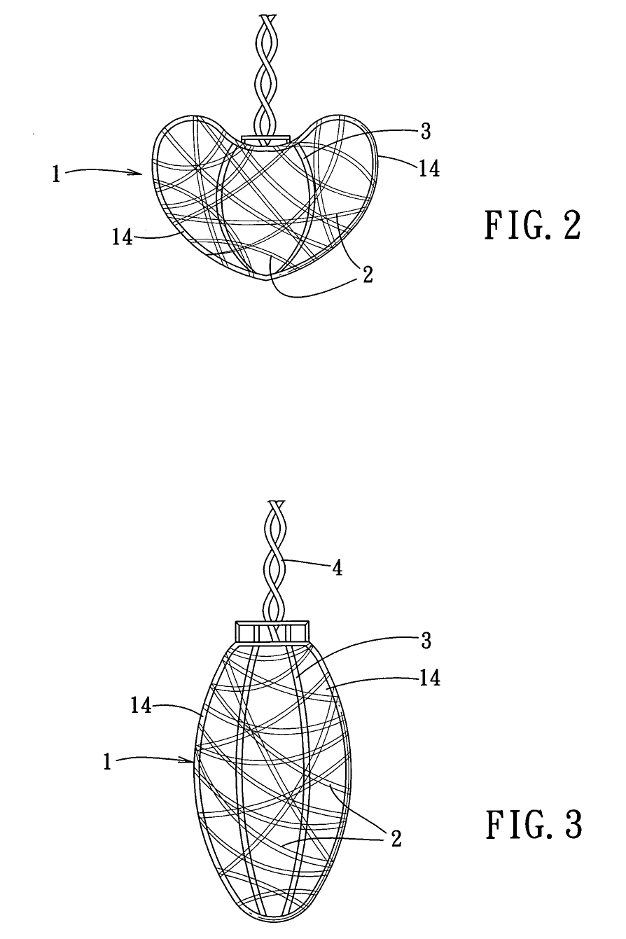

FIGS. 2 and 3 illustrate the second and third preferred embodiments of the decorative lampshade according to this invention. The lampshades of the first, second, and third preferred embodiments differ from each other in shape.

The light bulb 3 can include light emitting diode(s) as a light source.

With the inclusion of the transparent filaments 2 in the lampshade of this invention, the lampshade can produce a colorful and dazzling effect when the light bulb 3 is turned on, and the appearance of the lampshade can be enhanced accordingly.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A decorative lampshade comprising:
a frame defining an inner space and including a plurality of interconnected ribs surrounding said frame space; and
a plurality of transparent filaments disposed around said inner space and attached randomly to said ribs so as to form into a net-like structure surrounding said inner space.

2. The decorative lampshade as claimed in claim 1, wherein each of said transparent filaments is made of a thermoplastic material.

3. A decorative lamp comprising:
a frame defining an inner space and including a plurality of interconnected ribs surrounding said frame space, said inner space having a center region;
a plurality of transparent filaments disposed around said inner space and attached randomly to said ribs so as to form into a net-like structure surrounding said inner space; and
a light emitting element disposed at said center region of said inner space for emitting light through said net-like structure.
